(19) United States
(12) Patent Application Publication
(10) Pub. No.: US 2022/0318000 A1
(43) Pub. Date: Oct. 6, 2022

(54) COMMUNICATION APPARATUS AND PROGRAM

(71) Applicant: KYOCERA Corporation, Kyoto (JP)

(72) Inventors: Hiromichi NAKAI, Yokohama-shi (JP); Jun KATO, Yokohama-shi (JP)

(73) Assignee: KYOCERA Corporation, Kyoto (JP)

(21) Appl. No.: 17/808,401

(22) Filed: Jun. 23, 2022

Related U.S. Application Data
(63) Continuation of application No. PCT/JP2020/046098, filed on Dec. 10, 2020.

(30) Foreign Application Priority Data
Dec. 24, 2019 (JP) 2019-233509
Jun. 26, 2020 (JP) 2020-110969

(51) Int. Cl. G06F 8/658; G06F 8/656; H04L 67/00; H04L 67/1097

(52) U.S. Cl. CPC G06F 8/658; G06F 8/656; H04L 67/34; H04L 67/1097

(57) ABSTRACT

A communication apparatus 100 includes a firmware storage area that stores firmware of the communication apparatus 100, an update storage area 142b used for update processing of updating the firmware, a communicator 130 that receives a difference file indicating details of update for the firmware through wireless communication, and an update processor 141b that executes the update processing based on the difference file. The update processor 141b divides the firmware stored in the firmware storage area into a plurality of blocks and executes the update processing for each of the plurality of blocks using the update storage area 142b.

### RELATED APPLICATIONS

The present application is a continuation based on PCT Application No. PCT/JP2020/046098, filed on Dec. 10, 2020, which claims the benefit of Japanese Patent Application No. 2019-233509 filed on Dec. 24, 2019 and Japanese Patent Application No. 2020-110969 filed on Jun. 26, 2020, The content of which is incorporated by reference herein in their entirety.

### TECHNICAL FIELD

The present disclosure relates to a communication apparatus and a program.

### BACKGROUND ART

In recent years, a technology referred to as Firmware Over the Air (FOTA) has been widely used, in which firmware being a control program incorporated in an apparatus is distributed and updated through wireless communication (for example, see Patent Literature 1).

In FOTA, an apparatus receives a difference file (update file) indicating details of update for firmware through wireless communication. The apparatus reads from a firmware storage area that stores the firmware, compares the firmware with the difference file to update the firmware by using the update storage area, and writes the firmware after being updated in the firmware storage area.

### CITATION LIST

### Patent Literature

Patent Literature 1: Japanese application publication No. 2018-45406

### SUMMARY OF INVENTION

A communication apparatus according to the first aspect is a communication apparatus that performs wireless communication and includes a firmware storage area that stores firmware of the communication apparatus, an update storage area used for update processing of updating the firmware, a communicator that receives a difference file indicating details of update for the firmware through the wireless communication, and an update processor that executes the update processing based on the difference file. The update processor divides the firmware stored in the firmware storage area into a plurality of blocks and executes the update processing for each of the plurality of blocks using the update storage area.

A program according to the second aspect causes an information processing apparatus for distributing a difference file indicating details of update for firmware of a communication apparatus to execute processing of dividing firmware that is not updated into a plurality of blocks and dividing firmware that is updated into a plurality of blocks, processing of extracting difference data indicating details of update of the firmware that is updated relative to the firmware that is not updated in a unit of block, and processing of generating the difference file including the difference data in the unit of block.

### BRIEF DESCRIPTION OF DRAWINGS

FIG. 1 is a diagram illustrating a configuration of a communication system according to one embodiment.

FIG. 2 is a diagram illustrating a configuration of a communication apparatus according to one embodiment.

FIG. 3 is a diagram illustrating update processing of communication firmware according to one embodiment.

FIG. 4 is a diagram illustrating update processing of control firmware according to one embodiment.

FIG. 5 is a diagram illustrating a configuration of a server according to one embodiment.

FIG. 6 is a diagram illustrating firmware update operation in the communication apparatus according to one embodiment.

FIG. 7 is a diagram illustrating details of operation of the communication apparatus according to one embodiment.

FIG. 8 is a diagram illustrating operation of the communication apparatus according to modification example 1 of the embodiment.

FIG. 9 is a diagram illustrating a data flow when an information processing apparatus generates a difference file according to modification example 2.

FIG. 10 is a diagram illustrating an operation flow when the information processing apparatus generates a difference file according to modification example 2.

FIG. 11 is a diagram illustrating operation of the communication apparatus according to modification example 2.

### DESCRIPTION OF EMBODIMENTS

In FOTA, as storage capacity for an update storage area used for firmware update, a large storage capacity that can store the entire firmware is used. In particular, firmware of a communicator (for example, an LPWA communicator) of an apparatus has a large size, and thus if memory capacity of the apparatus is designed in accordance with the size of this firmware, a memory having large capacity will be installed in the apparatus. Thus, there is a problem in that costs of apparatuses that perform firmware update using FOTA increase due to increase of memory capacity.

In view of this, the present disclosure has an object to achieve firmware update using FOTA with a memory having small capacity.

Embodiments will be described with reference to the drawings. In the following description regarding the drawings, the same or similar parts are denoted by the same or similar reference signs.

### Configuration of Communication System

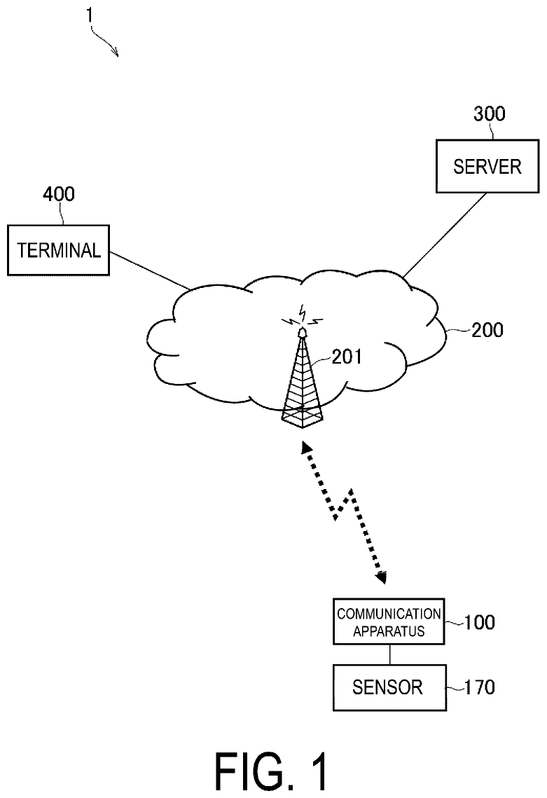

First, a configuration of a communication system according to one embodiment will be described. FIG. 1 is a diagram illustrating a configuration of a communication system 1 according to one embodiment.

As illustrated in FIG. 1, the communication system 1 includes a communication apparatus 100, a network 200, a server 300, and a terminal 400.

The communication apparatus 100 is an apparatus including a communication function, and is, for example, an apparatus used for the application of sensing such as remote monitoring or the like. The communication apparatus 100 has a configuration in which a user can customize a type of sensor used for measurement so that the communication apparatus 100 can support various services related to sensing. In one embodiment, one example in which the communication apparatus 100 is an apparatus used for the application of sensing will be described. However, the communication apparatus 100 may be any sort of apparatus as long as the communication apparatus 100 is an apparatus using FOTA and is an apparatus whose storage capacity of its installed memory is small.

In one embodiment, the communication apparatus 100 has a configuration in which a sensor 170 is removable, has high versatility, and can be provided at low costs. Here, “removable” is not limited to a case in which the sensor 170 is physically attachable (mountable) to and removable from the communication apparatus 100, but also includes a case in which the sensor 170 can be electrically connected to and disconnected from the communication apparatus 100 via a cable or the like. Note that the communication apparatus 100 is not limited to the configuration in which the sensor 170 is removable, but the sensor 170 may be installed in the communication apparatus 100.

The communication apparatus 100 transmits sensor data output by the sensor 170 to the server 300 via wireless communication with a base station 201 included in the network 200. For example, the communication apparatus 100 performs wireless communication of a Low Power Wide Area (LPWA) scheme. The LPWA scheme is a scheme of wireless communication for achieving long-range communication with reduced power consumption. The LPWA scheme includes, for example, cellular LPWA, Sigfox, or LoRaWAN. The cellular LPWA may include enhanced Machine Type Communications (eMTC) or Narrow Band-Internet of Things (NB-IoT) defined in the 3rd generation partnership project (3GPP) standard.

The network 200 is provided with the base station 201 that performs wireless communication with the communication apparatus 100. The network 200 includes a wide-frequency communication network (Wide Area Network (WAN)). The network 200 may further include the Internet.

The server 300 is connected to the network 200. The server 300 performs communication with the communication apparatus 100 via the network 200. For example, the server 300 performs various configurations with respect to the communication apparatus 100 and collects sensor data from the communication apparatus 100. The server 300 may not be a dedicated server. The server 300 may be a general-purpose terminal in which a predetermined application program is installed or may be a cloud server.

When the firmware of the communication apparatus 100 is updated, the server 300 provides a difference file indicating details of changes with respect to the current firmware of the communication apparatus 100 to the communication apparatus 100. The difference file includes a difference program corresponding to a difference of firmware before and after being updated and a version number indicating a version of the firmware after being updated. Note that the server 300 may be physically or logically divided into a server function for collecting the sensor data and a server function for providing the difference file.

The communication apparatus 100 receives the difference file through wireless communication and performs firmware update based on the received difference file. Such FOTA includes a push-type method in which a difference file is distributed from the server 300 to the communication apparatus 100 when there is firmware update. As a method in which firmware update is performed using the push type, there is a firmware update method using a protocol of Lightweight Machine to Machine (LwM2M) formulated in Open Mobile Alliance (OMA). FOTA includes a pull-type method in which the communication apparatus 100 inquires of the server 300 about presence or absence of firmware update, and then the communication apparatus 100 acquires a difference file from the server 300.

The terminal 400 accesses the server 300 via the network 200, receives information from the server 300, and displays the received information. For example, the terminal 400 displays a configuration screen for performing various configurations with respect to the communication apparatus 100 and displays sensor data collected by the server 300 on a remote monitoring screen. The terminal 400 may be a portable terminal, for example, a smartphone, a tablet terminal, a laptop PC, or a wearable terminal. The terminal 400 may be a stationary terminal, for example, a desktop PC.

In the terminal 400, dedicated application software for displaying information received from the server 300 may be installed. In the terminal 400, a general-purpose web browser for displaying information received from the server 300 may be installed.

### Configuration of Communication Apparatus

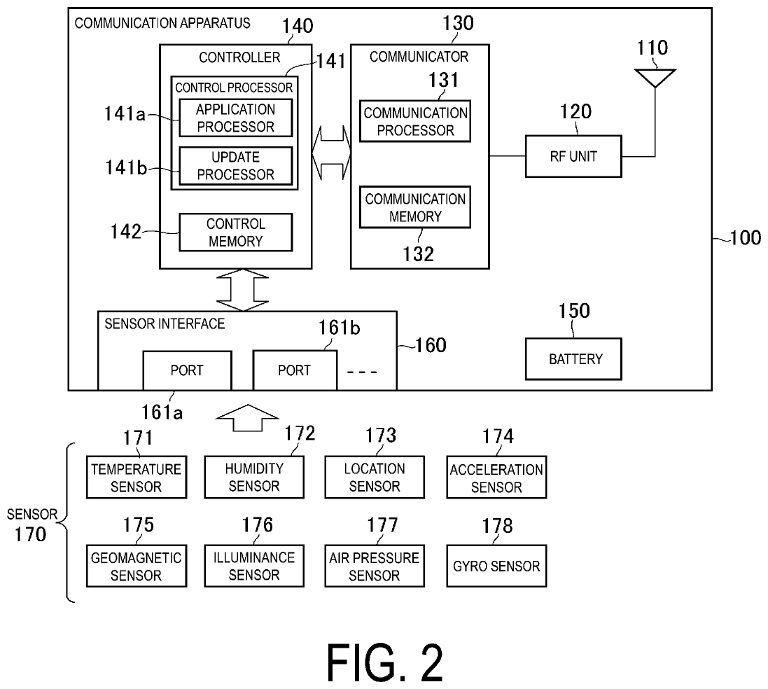

Next, a configuration of the communication apparatus 100 according to one embodiment will be described. FIG. 2 is a diagram illustrating a configuration of the communication apparatus 100 according to one embodiment.

As illustrated in FIG. 2, the communication apparatus 100 includes an antenna 110, a Radio Frequency (RF) unit 120, a communicator 130, a controller 140, a battery 150, and a sensor interface 160.

The antenna 110 and the RF unit 120 transmit and receive a radio signal. Specifically, the RF unit 120 performs amplification processing, filter processing, and the like on a radio signal received by the antenna 110, converts the radio signal into a baseband signal (reception signal), and outputs the resultant signal to the communicator 130. The RF unit 120 converts a baseband signal (transmission signal) output from the communicator 130 into a radio signal, performs amplification processing and the like, and transmits the resultant signal from the antenna 110.

The communicator 130 includes a communication processor 131 that performs communication processing in conformity to the LPWA scheme. The communication processor 131 may be referred to as a modem or a baseband processor. The communication processing includes processing of layer 1 and layer 2 of an OSI reference model. For example, the communication processor 131 performs demodulation processing, decoding processing, and the like on a reception signal output by the RF unit 120, and outputs reception data to the controller 140. The communication processor 131 performs coding processing, modulation processing, and the like on transmission data output by the controller 140, and outputs a transmission signal to the RF unit 120.

The communicator 130 includes a communication memory 132. The communication memory 132 stores communication firmware executed by the communication processor 131 and is also used as a work area of the communication processor 131. The communication memory 132 includes a non-volatile memory (ROM) that stores the communication firmware and the like and a volatile memory (RAM) used as the work area.

The controller 140 performs various types of processing and control in the communication apparatus 100. The controller 140 may be referred to as a microcontroller or a microcomputer. The controller 140 includes a control processor 141. The control processor 141 may be referred to as an application processor. For example, the control processor 141 executes an application, FOTA, a device driver, and each program (firmware) of an Operating System (OS). Details of the control processor 141 will be described below.

The controller 140 includes a control memory 142. The control memory 142 stores control firmware executed by the control processor 141 and is also used as a work area of the control processor 141. The control memory 142 includes a non-volatile memory (ROM) that stores the communication firmware and the like and a volatile memory (RAM) used as the work area.

Note that at least a part of the communication memory 132 and at least a part of the control memory 142 may be physically integrated with each other. For example, the ROM included in the communication memory 132 and the ROM included in the control memory 142 may be physically integrated with each other, or the RAM included in the communication memory 132 and the RAM included in the control memory 142 may be physically integrated with each other.

The battery 150 includes a primary battery or a secondary battery and supplies electrical power for driving the communication apparatus 100.

The sensor interface 160 is an interface to which the sensor 170 is electrically connected. For example, the sensor interface 160 is configured in conformity to one of the Universal Serial Bus (USB) standard, the Universal Asynchronous Receiver/Transmitter (UART) standard, and the Inter-Integrated Circuit (I2C) standard. The sensor interface 160 may be connected to the sensor 170 without using a cable therebetween.

The sensor 170 that may be connected to the sensor interface 160 is, for example, at least one of a temperature sensor 171, a humidity sensor 172, a location sensor 173, an acceleration sensor 174, a geomagnetic sensor 175, an illuminance sensor 176, an air pressure sensor 177, or a gyro sensor 178. The user of the communication apparatus 100 purchases a sensor 170 that meets the needs of the user themselves as necessary and mounts the sensor 170 to the communication apparatus 100. The sensor 170 mounted to the communication apparatus 100 can be removed or replaced by the user. The communication apparatus 100 includes a plurality of ports 161a, 161b, . . . . Individual sensors 170 are electrically connected to respective ports.

Note that the temperature sensor 171 is a sensor that measures temperature and outputs temperature data as sensor data. The humidity sensor 172 is a sensor that measures humidity and outputs humidity data as sensor data. The location sensor 173 is a sensor that measures location and outputs location data as sensor data. For example, the location sensor 173 is configured to include a GNSS receiver. The acceleration sensor 174 is a sensor that measures acceleration and outputs acceleration data as sensor data. The acceleration sensor 174 may be a uni-axial acceleration sensor or may be a multi-axial acceleration sensor. The geomagnetic sensor 175 is a sensor that measures geomagnetic fields and outputs geomagnetic data as sensor data. The illuminance sensor 176 is a sensor that measures illuminance and outputs illuminance data as sensor data. The air pressure sensor 177 is a sensor that measures air pressure and outputs air pressure data as sensor data. The gyro sensor 178 is a sensor that measures angular velocity and outputs angular velocity data as sensor data.

In the communication apparatus 100 configured as described above, the controller 140 controls the communicator 130 so as to perform transmission processing (hereinafter referred to as “data transmission processing”) of transmitting sensor data obtained by the sensor 170 to the server 300. For example, the controller 140 determines whether a preset transmission condition is satisfied. When the transmission condition is satisfied, the communicator 130 performs the data transmission processing. The transmission condition may be a condition that sensor data (sensor value) of a specific sensor 170 exceeds or falls below a threshold. Alternatively, the controller 140 may control the communicator 130 so as to periodically execute the data transmission processing.

The communicator 130 may be configured to a power saving mode in a period during which the communicator 130 does not perform the data transmission processing. The power saving mode may be a mode in which power supply to the RF unit 120 and the communicator 130 is stopped. The power saving mode may be Power Saving Mode (PSM) or extended Discontinuous Reception (eDRX) defined in the Third Generation Partnership Project (3GPP) standard.

The control processor 141 of the controller 140 includes an application processor 141a and an update processor 141b. The application processor 141a is a functional unit corresponding to an application program being one type of control firmware. The update processor 141b is a functional unit corresponding to a firmware update function for performing firmware update using FOTA.

The update processor 141b may use the pull-type firmware update method. Specifically, the update processor 141b accesses the server 300, inquires of the server 300 about presence or absence of firmware update, and then acquires a difference file from the server 300. The update processor 141b updates firmware to be updated, using the acquired difference file.

The firmware to be updated may be control firmware or may be communication firmware. Typically, the size of the communication firmware is larger than the size of the control firmware.

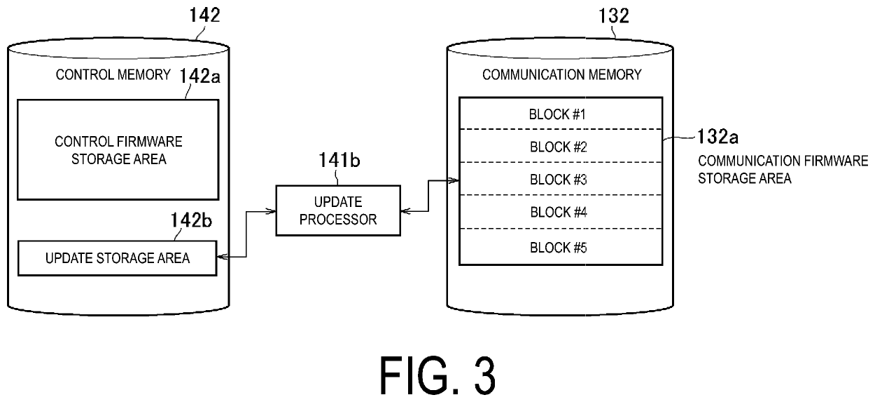

FIG. 3 is a diagram illustrating update processing of the communication firmware according to one embodiment.

As illustrated in FIG. 3, the communication memory 132 provided in the communicator 130 includes a communication firmware storage area 132a that stores the communication firmware. For example, the communication firmware storage area 132a is provided in the non-volatile memory included in the communication memory 132.

The control memory 142 provided in the controller 140 includes a control firmware storage area 142a that stores control firmware and an update storage area 142b that is used for update processing of the communication firmware. For example, the control firmware storage area 142a is provided in the non-volatile memory included in the control memory 142. The update storage area 142b is provided in the volatile memory included in the control memory 142.

When FOTA for updating the communication firmware is started, the communicator 130 receives a difference file indicating details of update for the communication firmware through wireless communication. The update processor 141b causes the control memory 142 (the update storage area 142b or another storage area) to store the difference file received by the communicator 130.

The update processor 141b executes the update processing of the communication firmware based on the difference file. Here, the update processor 141b divides the communication firmware stored in the communication firmware storage area 132a into a plurality of blocks (in the example of FIG. 3, blocks #1 to #5) and executes the update processing for each block using the update storage area 142b. FIG. 3 illustrates one example in which the size (block size) of each of the plurality of blocks of the communication firmware is fixed. The block size is a size equal to or smaller than the size of the storage capacity of the update storage area 142b.

For example, when the update processor 141b executes the update processing for each block using the update storage area 142b, the update processor 141b 1) reads a target block (for example, block #1) included in the plurality of blocks #1 to #5 from the communication firmware storage area 132a and writes the target block in the update storage area 142b, 2) compares the target block with the difference file in the update storage area 142b to update the target block, and 3) reads the target block that is updated from the update storage area 142b and writes (writes back) the target block that is updated in the communication firmware storage area 132a. For example, when the update processor 141b updates block #1 of the communication firmware, the update processor 141b overwrites block #1 before being updated with block #1 after being updated.

The update processor 141b writes the target block that is updated in the communication firmware storage area 132a and confirms whether the writing has correctly completed. When it is confirmed that the writing has correctly completed, the update processor 141b executes the update processing of the above 1) to 3), with the next block (for example, block #2) as a target block.

By using the operation of the update processor 141b as described above, the storage capacity of the update storage area 142b suffices to be small storage capacity in accordance with the size of one block instead of large storage capacity in accordance with the size of the entire communication firmware. Therefore, costs of the memory can be reduced.

Because the communication firmware input and output by the communication memory 132 is divided into units of blocks, it is difficult to detect the details of the communication firmware even if a malicious third party acquires and analyzes memory input and output data. Therefore, security can be enhanced.

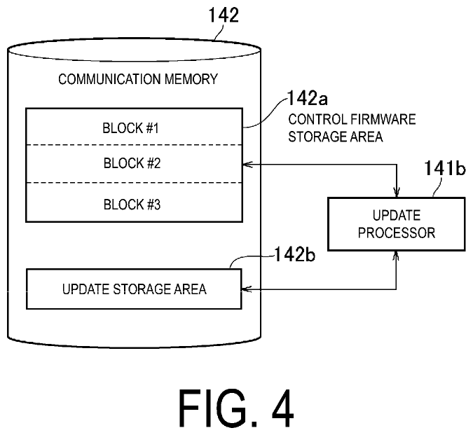

FIG. 4 is a diagram illustrating update processing of the control firmware according to one embodiment.

As illustrated in FIG. 4, the control memory 142 provided in the controller 140 includes a control firmware storage area 142a that stores control firmware and an update storage area 142b that is used for update processing of the control firmware.

The update storage area 142b is used not only for the update processing of the communication firmware described above, but also for the update processing of the control firmware. In other words, the update storage area 142b is shared in the update processing of the communication firmware and the update processing of the control firmware. With this configuration, it is possible to avoid providing the update storage area 142b in the communication memory 132, and therefore storage capacity of the communication memory 132 can be reduced.

When FOTA for updating the control firmware is started, the communicator 130 receives a difference file indicating details of update for the control firmware through wireless communication. The update processor 141b causes the control memory 142 (the update storage area 142b or another storage area) to store the difference file received by the communicator 130.

The update processor 141b executes the update processing of the control firmware based on the difference file. Here, the update processor 141b divides the control firmware stored in the control firmware storage area 142a into a plurality of blocks (in the example of FIG. 4, blocks #1 to #3) and executes the update processing for each block using the update storage area 142b. FIG. 4 illustrates one example in which the size (block size) of each of the plurality of blocks of the control firmware is fixed. The block size is a size equal to or smaller than the size of the storage capacity of the update storage area 142b.

For example, when the update processor 141b executes the update processing for each block using the update storage area 142b, the update processor 141b 1) reads a target block (for example, block #1) included in the plurality of blocks #1 to #3 from the control firmware storage area 142a and writes the target block in the update storage area 142b, 2) compares the target block with the difference file in the update storage area 142b to update the target block, and 3) reads the target block that is updated from the update storage area 142b and writes (writes back) the target block that is updated in the control firmware storage area 142a. For example, when the update processor 141b updates block #1 of the control firmware, the update processor 141b overwrites block #1 before being updated with block #1 after being updated.

The update processor 141b writes the target block that is updated in the control firmware storage area 142a and confirms whether the writing has correctly completed. When it is confirmed that the writing has correctly completed, the update processor 141b executes the update processing of the above 1) to 3), with the next block (for example, block #2) as a target block.

By using the operation of the update processor 141b as described above, the storage capacity of the update storage area 142b suffices to be small storage capacity in accordance with the size of one block instead of large storage capacity in accordance with the size of the entire control firmware.

### Configuration of Server

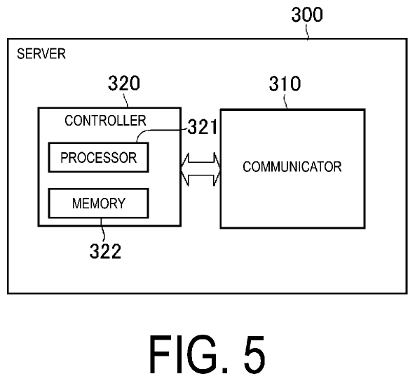

Next, a configuration of the server 300 according to one embodiment will be described. FIG. 5 is a diagram illustrating a configuration of the server 300 according to one embodiment.

As illustrated in FIG. 5, the server 300 includes a communicator 310 and a controller 320. The communicator 310 includes, for example, a wired communication interface. The communicator 310 is connected to the network 200 and performs communication with the communication apparatus 100 via the network 200.

The controller 320 performs various types of processing and control in the server 300. The controller 320 includes a processor 321 and a memory 322. The memory 322 stores a program executed by the processor 321 and is also used as a work area of the processor 321. The memory 322 includes an auxiliary storage device such as an HDD or an SSD.

The controller 320 executes processing of collecting and managing sensor data from the communication apparatus 100 and processing of providing a difference file for updating firmware of the communication apparatus 100 to the communication apparatus 100. In order to collect sensor data, the communicator 310 performs reception processing of receiving, from the communication apparatus 100, sensor data obtained by the communication apparatus 100 from the sensor 170. The controller 320 stores and manages the sensor data received from the communication apparatus 100.

### Operation Example of Communication Apparatus

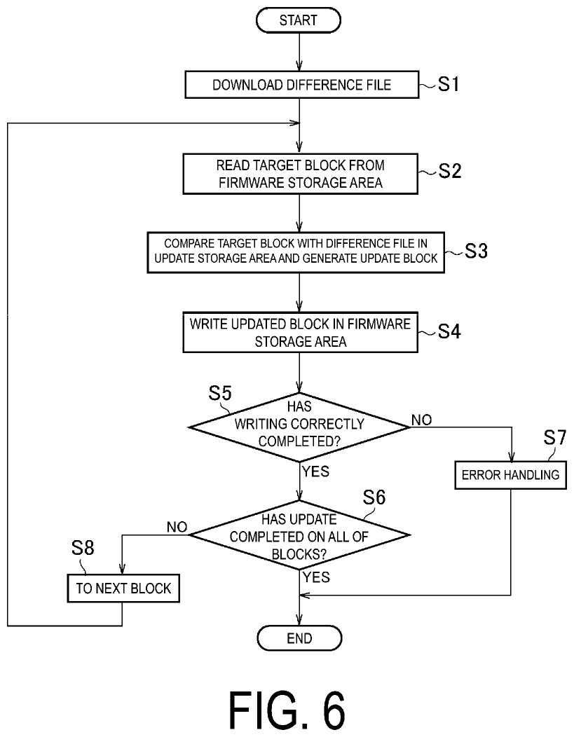

FIG. 6 is a diagram illustrating firmware update operation in the communication apparatus 100 according to one embodiment. Here, description will be given by taking an example of update operation of the communication firmware.

As illustrated in FIG. 6, in Step S1, the update processor 141b downloads a difference file.

In Step S2, the update processor 141b reads a target block (for example, block #1) of the communication firmware stored in the communication firmware storage area 132a and writes the target block in the update storage area 142b.

In Step S3, the update processor 141b compares the target block with the difference file in the update storage area 142b to update the target block.

In Step S4, the update processor 141b reads the target block that is updated (updated block) from the update storage area 142b and writes (writes back) the updated block in the communication firmware storage area 132a.

In Step S5, the update processor 141b determines whether the writing of the updated block in the communication firmware storage area 132a has correctly completed.

In a case of “NO” in Step S5, in Step S7, the update processor 141b executes error handling. The error handling may be processing of attempting the writing of the updated block in the communication firmware storage area 132a again. The error handling may be processing of starting the operation on the same target block over again from Step S2. The error handling may be processing of ending the update operation as a firmware update failure.

In a case of “YES” in Step S5, in Step S6, the update processor 141b determines whether update has completed on all of the blocks. In a case of “YES” in Step S6, the update operation ends.

In a case of “NO” in Step S6, in Step S8, the update processor 141b selects the next block as a target block. Then, the update processor 141b executes the processing from Step S2 on the next block.

### Gist of Embodiments

As described above, the communication apparatus 100 divides the communication firmware or the control firmware into a plurality of blocks and executes the update processing for each block using the update storage area 142b. With this configuration, the storage capacity of the update storage area 142b suffices to be small storage capacity in accordance with the size of one block instead of large storage capacity in accordance with the size of the entire firmware. Accordingly, a memory having small capacity can be installed as the control memory 142. Therefore, reduction of costs of the communicator 130 can be achieved.

In one embodiment, the update processor 141b writes a target block that is updated in the communication firmware storage area 132a or the control firmware storage area 142a and confirms whether the writing has correctly completed. When it is confirmed that the writing has correctly completed, the update processor 141b executes the update processing with the next block being a target block. With this configuration, reliability of firmware update can be enhanced.

In one embodiment, the update processor 141b uses the same update storage area 142b in both the update processing for the communication firmware and the update processing for the control firmware. With this configuration, storage capacity of the entire memory can be reduced as compared to a case in which separate update storage areas are used in the update processing for the communication firmware and the update processing for the control firmware.

In one embodiment, the size of each of the plurality of blocks is fixed. For example, small storage capacity can be easily used for the update storage area 142b in accordance with the size of one block.

### Modification Example 1

Next, modification example 1 of the embodiment will be described.

As described above, FOTA is used for updating firmware using wireless communication. FOTA is used not only for addition and improvement of a function but is also used when correcting a serious malfunction. Thus, although a volatile memory (RAM) is typically shared in a regular application, FOTA includes a dedicated RAM to ensure its operation without fail. However, since FOTA is not a frequently operating function, it is desirable to reduce a memory used in FOTA even just a little from the viewpoint of effectively using the RAM in a small memory apparatus.

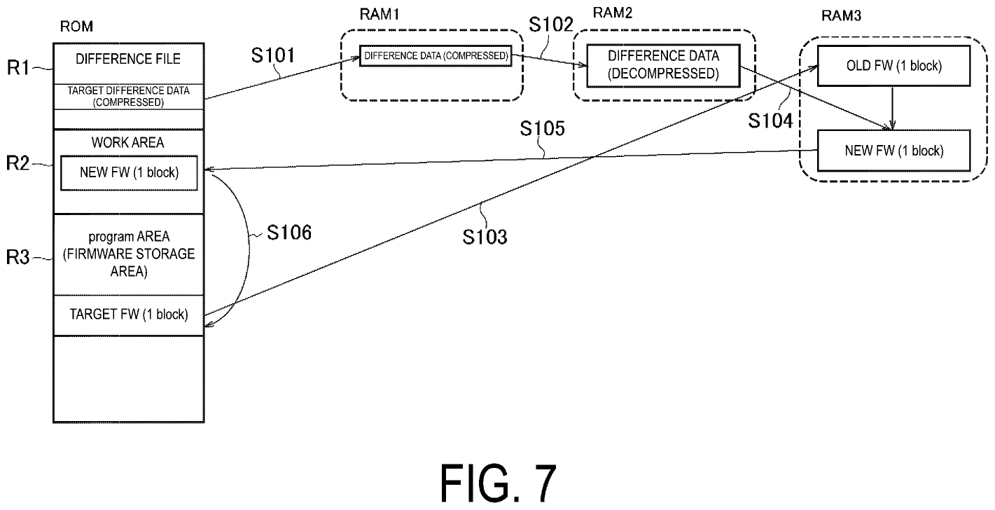

Here, prior to description of operation according to modification example 1, details of the operation according to the embodiment described above will be described. FIG. 7 is a diagram illustrating details of operation of the communication apparatus 100 according to the embodiment. Note that, in the drawings, firmware is abbreviated as FW.

As illustrated in FIG. 7, the communication apparatus 100 includes a ROM constituting a non-volatile memory area and a RAM 1 to a RAM 3 each constituting a volatile memory area. The ROM may be an Electrically Erasable Programmable Read-Only Memory (EEPROM) such as a flash memory.

The ROM is a non-volatile memory included in the control memory 142 and/or the communication memory 132. The RAM 1 to the RAM 3 are each a volatile memory included in the control memory 142 and/or the communication memory 132. In modification example 1, the RAM 1 to the RAM 3 constitute the update storage area 142b.

The ROM includes a storage area R1 that stores the difference file received by the communicator 130 through wireless communication, a storage area R2 used as a work area, and a storage area R3 that stores a program (firmware). The storage area R3 is a storage area corresponding to the control firmware storage area 142a or the communication firmware storage area 132a.

In Step S101 of FIG. 7, the update processor 141b writes, in the RAM 1, a difference file (difference data) read from the storage area R1 of the ROM. Here, the difference file is in a compressed state.

In Step S102, the update processor 141b decompresses the difference file stored in the RAM 1 and writes the decompressed difference file in the RAM 2.

In Step S103, the update processor 141b reads one block (target block) of firmware that is not updated from the storage area R3 of the ROM and writes the read target block in the RAM 3.

In Step S104, the update processor 141b compares the decompressed difference file (difference data) stored in the RAM 2 and the target block stored in the RAM 3 to update the target block. Here, the RAM 3 is used as a non-volatile memory for comparison processing. Note that the target block after being updated constitutes one block of firmware that is updated.

In Step S105, the update processor 141b reads the updated target block stored in the RAM 3 and writes the read updated target block in the storage area R2 of the ROM. Here, the updated target block is written in the storage area R2 being a work area in order to enable resumption from an interrupted part in the event of sudden power failure or the like.

In Step S106, the update processor 141b reads the updated target block stored in the storage area R2 of the ROM and writes the read updated target block in the storage area R3 of the ROM. Here, the update processor 141b may overwrite the target block of firmware that is not updated with the updated target block.

By performing such operation on all of the blocks, firmware stored in the storage area R3 of the ROM is updated. However, in such operation, a total of three RAMs, i.e., the RAM 1 to the RAM 3, are used.

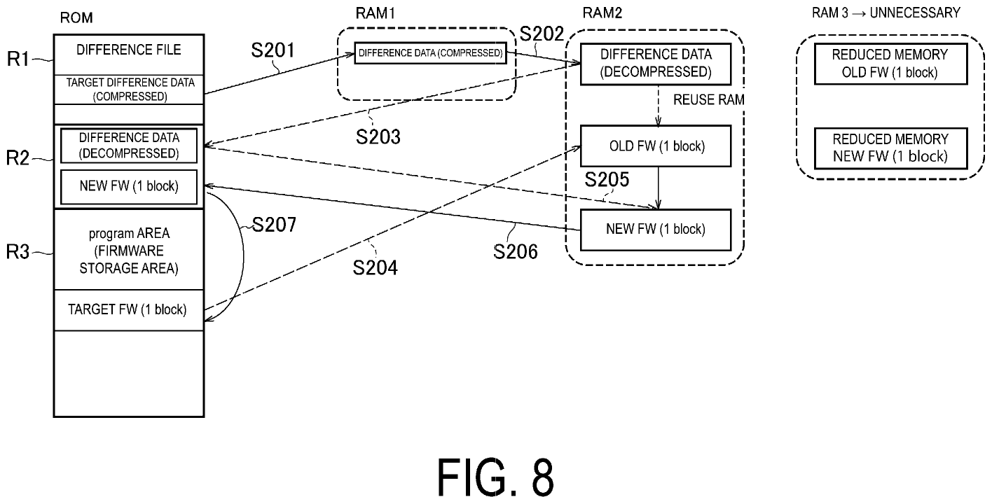

Next, operation of the communication apparatus 100 according to modification example 1 of the embodiment will be described. FIG. 8 is a diagram illustrating operation of the communication apparatus 100 according to modification example 1 of the embodiment. Here, differences from the operation of FIG. 7 will be mainly described.

As illustrated in FIG. 8, in Step S201, the update processor 141b writes, in the RAM 1, a difference file (difference data) read from the storage area R1 of the ROM. Here, the difference file is in a compressed state.

In Step S202, the update processor 141b decompresses the difference file stored in the RAM 1 and writes the decompressed difference file in the RAM 2.

In Step S203, the update processor 141b reads the decompressed difference file (difference data) stored in the RAM 2 and writes the read decompressed difference file in the storage area R2 of the ROM. In other words, the update processor 141b saves the decompressed difference file stored in the RAM 2 in the work area (storage area R2) of the ROM.

In Step S204, the update processor 141b reads one block (target block) of firmware that is not updated from the storage area R3 of the ROM and writes the read target block in the RAM 2. In other words, the RAM 2 is reused.

In Step S205, the update processor 141b compares the decompressed difference file (difference data) stored in the storage area R2 of the ROM and the target block stored in the RAM 2 to update the target block. The target block after being updated constitutes one block of firmware that is updated.

In Step S206, the update processor 141b reads the updated target block stored in the RAM 2 and writes the read updated target block in the storage area R2 of the ROM.

In Step S207, the update processor 141b reads the updated target block stored in the storage area R2 of the ROM and writes the read updated target block in the storage area R3 of the ROM. Here, the update processor 141b may overwrite the target block of firmware that is not updated with the updated target block.

By performing such operation on all of the blocks, firmware stored in the storage area R3 of the ROM is updated.

The update processor 141b according to modification example 1 decompresses a difference file being a compressed file in the volatile memory area (RAM 2) and subsequently saves the decompressed difference file in the non-volatile memory area (storage area R2 of the ROM). Then, the update processor 141b writes the target block in the volatile memory area (RAM 2) and subsequently compares the target block stored in the volatile memory area (RAM 2) with the difference file stored in the non-volatile memory area (storage area R2 of the ROM) to update the target block.

By saving the decompressed difference file in the non-volatile memory area (storage area R2 of the ROM), the volatile memory area (RAM 2) can be reused for the comparison processing, which can make the RAM 3 for the comparison processing unused. Accordingly, the number of RAMs used for FOTA can be reduced from three to two, and therefore FOTA can be more easily implemented in a small memory apparatus.

### Modification Example 2

Next, modification example 2 of the embodiment will be described.

When a difference file is decompressed during the update processing using FOTA, the decompressed difference file may exceed a RAM area prepared in advance, depending on data patterns of firmware that is not updated (old FW) and firmware that is updated (new FW). In this case, there is a problem in that RAM size over occurs, and update using FOTA fails. Modification example 2 is an example for solving such a problem.

Specifically, when the size of difference data corresponding to a certain block exceeds the RAM size prepared in advance in the communication apparatus 100, an information processing apparatus that creates a difference file determines that the certain block is not the difference data, treats the block of new FW as the difference data, and continues processing.

Here, the information processing apparatus that creates a difference file may be the server 300 illustrated in FIG. 1 or may be an apparatus that provides a difference file to the server 300. The information processing apparatus is at least one computer including at least one processor and at least one memory.

Then, when the information processing apparatus adds a block of new FW in place of the difference data, the information processing apparatus adds information indicating that the block is not the difference data in a header of the block. When the update processor 141b of the communication apparatus 100 reads a header in FOTA processing and the header indicates that the block is not the difference data, the update processor 141b skips difference application processing of the block.

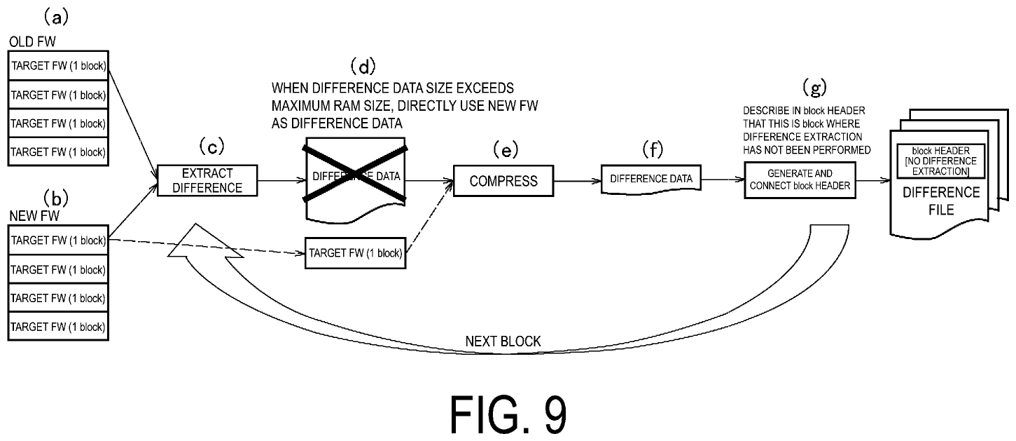

FIG. 9 is a diagram illustrating a data flow when the information processing apparatus according to modification example 2 generates a difference file.

As illustrated in FIGS. 9(a) and (b), the information processing apparatus divides firmware that is not updated (old FW) into a plurality of blocks and divides firmware that is updated (new FW) into a plurality of blocks. The size of each block and the number of block divisions may be fixed.

As illustrated in FIG. 9(c), the information processing apparatus acquires one block (hereinafter referred to as an “block that is not updated”) of the firmware that is not updated, acquires one block (hereinafter referred to as an “block that is updated”) corresponding to the block that is not updated of the firmware that is updated, extracts a difference between the block that is not updated and the block that is updated, and generates difference data.

As illustrated in FIG. 9(d), the information processing apparatus determines whether the size of the generated difference data exceeds a predetermined size (maximum RAM size). When the size does not exceed the predetermined size, the information processing apparatus selects the difference data, whereas when the size exceeds the predetermined size, the information processing apparatus selects the block that is updated as the difference data.

As illustrated in FIG. 9(e), the information processing apparatus compresses the selected difference data (which may be the block that is updated).

As illustrated in FIGS. 9(f) and (g), the information processing apparatus generates a header to be connected to the compressed difference data. Here, when the compressed difference data is the block that is updated, the information processing apparatus generates a header including information indicating that this is data where the difference extraction has not been performed and connects the header to the compressed difference data. What is obtained by connecting the compressed difference data and the header is referred to as a file.

The information processing apparatus applies such operation to all of the blocks and thereby generates a difference file consisting of a plurality of files corresponding to the plurality of blocks. Then, the difference file generated by the information processing apparatus is distributed from the server 300 to the communication apparatus 100 illustrated in FIG. 1.

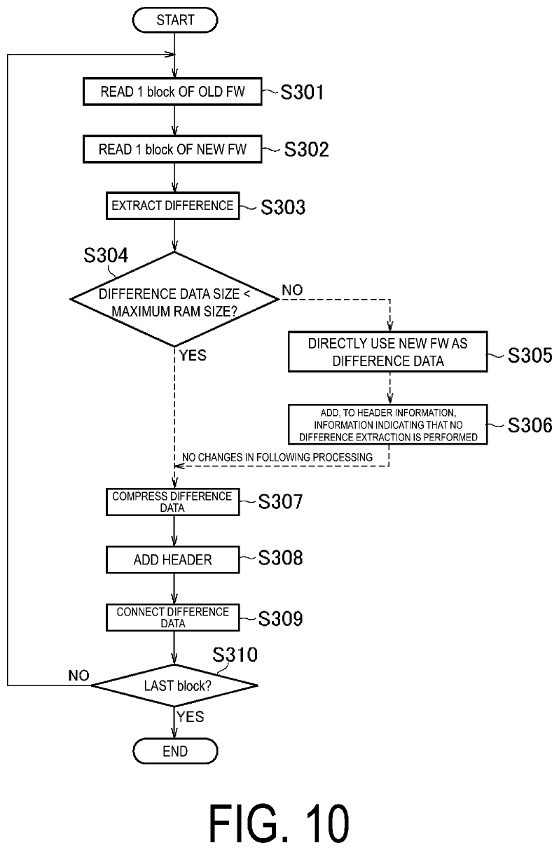

FIG. 10 is a diagram illustrating an operation flow when the information processing apparatus according to modification example 2 generates a difference file.

As illustrated in FIG. 10, in Step S301, the information processing apparatus reads one block that is not updated of firmware that is not updated.

In Step S302, the information processing apparatus reads one block (block that is updated) corresponding to the one block that is not updated of firmware that is updated.

In Step S303, the information processing apparatus extracts a difference between the block that is not updated and the block that is updated and generates difference data.

In Step S304, the information processing apparatus determines whether the size of the generated difference data is smaller than a predetermined size (maximum RAM size). When the size of the generated difference data is smaller than the predetermined size (Step S304: YES), the information processing apparatus advances the processing to Step S307.

In contrast, when the size of the generated difference data is equal to or larger than the predetermined size (Step S304: NO), the information processing apparatus directly uses the block that is updated as the difference data (Step S305), adds, to the header information of the block, information indicating that no difference extraction is performed (Step S306), and advances the processing to Step S307.

In Step S307, the information processing apparatus compresses the difference data (which may be the block that is updated).

In Step S308, the information processing apparatus adds a header. Then, the information processing apparatus connects the header to the compressed difference data (Step S309).

In Step S310, the information processing apparatus determines whether the block is the last block. When the block is the last block (Step S310: YES), the present operation ends. In contrast, when the block is not the last block (Step S310: NO), the information processing apparatus brings the processing back to Step S301 and resumes the operation with the next block as a target.

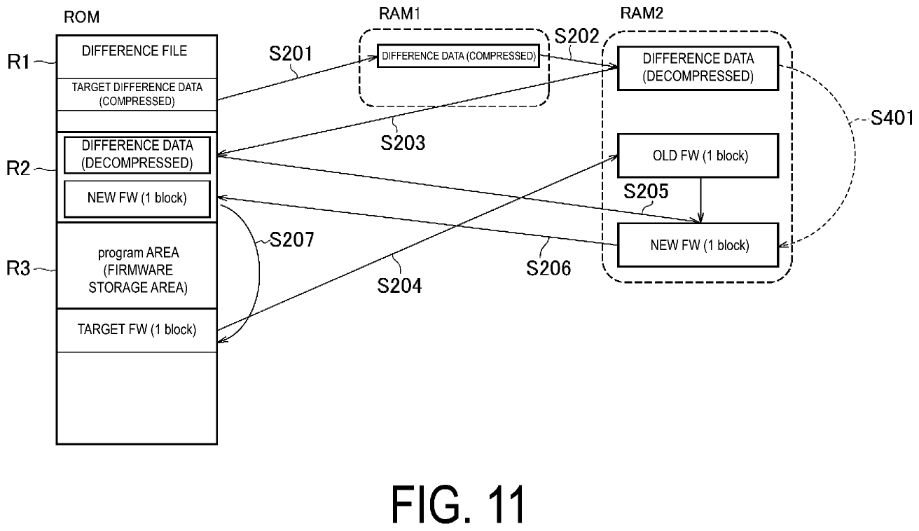

Next, operation of the communication apparatus 100 according to modification example 2 will be described. FIG. 11 is a diagram illustrating operation of the communication apparatus 100 according to modification example 2. Here, differences from the operation of FIG. 8 will be mainly described.

As illustrated in FIG. 11, the update processor 141b of the communication apparatus 100 writes, in the RAM 1, a difference file (difference data) read from the storage area R1 of the ROM (Step S201), decompresses the difference file stored in the RAM 1, and writes the decompressed difference file in the RAM 2 (Step S202).

Here, the update processor 141b decodes a header of the difference data of the block and determines whether information indicating that no difference extraction is performed is included in the header. When the information indicating that no difference extraction is performed is not included in the header, the difference data corresponding to the header is processed similarly to modification example 1 of the embodiment described above.

In contrast, when the information indicating that no difference extraction is performed is included in the header, the update processor 141b treats the difference data corresponding to the header as a block that is updated (Step S401) and writes the block that is updated in the storage area R2 of the ROM (Step S206). In other words, based on additional information (header information) included in the difference file, the update processor 141b identifies a file including a block of firmware that is updated out of a plurality of files constituting the difference file and writes the block of the firmware that is updated in the ROM (firmware storage area).

As described above, in modification example 2, the information processing apparatus for distributing a difference file executes processing of dividing each of the firmware that is not updated and the firmware that is updated into a plurality of blocks, processing of extracting difference data indicating details of update of the firmware that is updated relative to the firmware that is not updated in a unit of block, and processing of generating a difference file including the difference data in the unit of block. When the size of difference data corresponding to a specific block exceeds a predetermined size, the information processing apparatus includes firmware that is updated corresponding to the specific block in the difference file, instead of including the difference data corresponding to the specific block in the difference file.

With this configuration, the size of a decompressed difference file (difference data) can be prevented from exceeding the RAM area prepared in advance, and occurrence of RAM size over can be prevented, which can thus lead to reduction of a case in which update using FOTA may fail.

### Other Embodiments

The embodiment described above describes one example in which the size of each of the plurality of blocks is fixed. However, the size of each of the plurality of blocks may be variable. With the block size being variable, for example, an optimal division method can be specified depending on the size of firmware. When the block size is made variable, additional information for determining the size of each of the plurality of blocks may be added to the difference file. The additional information includes at least one of information indicating the number of divisions of the firmware or information indicating the size of each block. The update processor 141b determines the size of each of the plurality of blocks based on the additional information and divides the firmware in accordance with the determined size of each block.

There may be provided a program that causes a computer to execute the processing operations performed by the communication apparatus 100 or the information processing apparatus. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM, a DVD-ROM, or the like.

The functional units (circuits) for executing the processing operations performed by the communication apparatus 100 may be integrated, and at least a part of the communication apparatus 100 may be configured as a semiconductor integrated circuit (a chipset or an SoC).

Embodiments have been described above in detail with reference to the drawings, but specific configurations are not limited to those described above, and various design modifications can be made without departing from the gist of the present disclosure.

1. A communication apparatus configured to perform wireless communication, the communication apparatus comprising:
a firmware storage area configured to store firmware of the communication apparatus;
an update storage area used for update processing of updating the firmware;
a communicator configured to receive a difference file indicating details of update for the firmware through the wireless communication; and
an update processor configured to execute the update processing based on the difference file, wherein
the update processor is configured to divide the firmware stored in the firmware storage area into a plurality of blocks, and execute the update processing for each of the plurality of blocks using the update storage area.

2. The communication apparatus according to claim 1, wherein
when the update processor executes the update processing for each of the plurality of blocks using the update storage area, the update processor is configured to
read a target block included in the plurality of blocks from the firmware storage area, and write the target block in the update storage area,
compare the target block with the difference file in the update storage area to update the target block, and
read, from the update storage area, the target block that is updated, and write, in the firmware storage area, the target block that is updated.

3. The communication apparatus according to claim 2, wherein
the update processor is configured to
perform writing of the target block that is updated in the firmware storage area, and confirm whether the writing is correctly completed, and
when the writing is confirmed to be correctly completed, execute the update processing with a next block of the plurality of blocks as the target block.

4. The communication apparatus according to claim 1, wherein
a size of each of the plurality of blocks is fixed.

5. The communication apparatus according to claim 1, wherein
a size of each of the plurality of blocks is variable,
additional information for determining the size of each of the plurality of blocks is added to the difference file, and
the update processor is configured to determine the size of each of the plurality of blocks based on the additional information.

6. The communication apparatus according to claim 1, wherein
the firmware includes communication firmware and control firmware, and
the update processor is configured to use the update storage area that is identical for both the update processing on the communication firmware and the update processing on the control firmware.

7. The communication apparatus according to claim 1, further comprising
a controller configured to control the communicator, wherein
the controller includes
a control processor configured to operate as the update processor, and
a control memory including the update storage area.

8. The communication apparatus according to claim 2, wherein
the update storage area includes a volatile memory area, and
the update processor is configured to
decompress the difference file being a compressed file in the volatile memory area, and save the difference file that is decompressed in a non-volatile memory area, and
write the target block in the volatile memory area, and subsequently compare the target block stored in the volatile memory area with the difference file stored in the non-volatile memory area to update the target block.

9. The communication apparatus according to claim 1, wherein
the difference file includes a plurality of files corresponding to the plurality of blocks stored in the firmware storage area, and
the update processor is configured to
identify a file including a block of firmware that is updated out of the plurality of files, based on the additional information included in the difference file, and
write, in the firmware storage area, the block of the firmware that is updated included in the file that is identified.

10. A program configured to cause an information processing apparatus for distributing a difference file indicating details of update for firmware of a communication apparatus to execute:
processing of dividing firmware that is not updated into a plurality of blocks and dividing firmware that is updated into a plurality of blocks;
processing of extracting difference data indicating details of update of the firmware that is updated relative to the firmware that is not updated in a unit of block; and
processing of generating the difference file including the difference data in the unit of block.

11. The program according to claim 10, wherein
the program is configured to cause the information processing apparatus to further execute:
processing of, when a size of the difference data corresponding to a specific block exceeds a predetermined size, including the firmware that is updated corresponding to the specific block in the difference file, instead of including the difference data corresponding to the specific block in the difference file.
